(19) United States
(12) Patent Application Publication
(10) Pub. No.: US 2022/0219618 A1
(43) Pub. Date: Jul. 14, 2022

(54) CLAMP-TYPE FITTING SEAT AND HOLDER

(71) Applicant: SHENZHEN DIYIWEI ELECTRONICS CO., LTD., Shenzhen (CN)

(72) Inventors: Yuchen Zheng, Shenzhen (CN); Fan Yu, Shenzhen (CN)

(21) Appl. No.: 17/384,798

(22) Filed: Jul. 25, 2021

(30) Foreign Application Priority Data
Jan. 11, 2021 (CN) 202120067487.0

(51) Int. Cl. B60R 11/02; F16M 13/02; F16M 11/14; F16M 11/04

(52) U.S. Cl. CPC B60R 11/0252; B60R 11/0241; B60R 2011/0071; F16M 11/14; F16M 11/041; F16M 13/022

(57) ABSTRACT

Disclosed is a fitting seat which may include an interconnecting piece and a coupling head arranged on the interconnecting piece. Two ends of the interconnecting piece may be bent toward each other to form first clamping parts. Each of the first clamping parts may have a first bending portion and a second bending portion which are bent in opposite direction. When the fitting seat is clamped to two connecting rods, the two second bending portions are abutted and pressed against the two connecting rods so that the fitting seat is able to clamp the connecting rods; meanwhile, the first bending portions may increase the deformability of the fitting seat, making the first clamping parts difficult to break and resulting in good stability and simple structure.

### CROSS REFERENCE TO RELATED APPLICATIONS

The present application claims the benefit of Chinese Patent Application No. 202120067487.0 filed on Jan. 11, 2021, the contents of which are incorporated herein by reference in their entirety.

### TECHNICAL FIELD

The present disclosure relates to support, in particular to clamp-type fitting seats and holders.

### BACKGROUND OF THE INVENTION

Mobile phones and tablets may be main recreational tools when people ride in vehicles. However, holding a mobile phone or tablet with a hand may make people get tired very easily; further, the hand holding the mobile phone or tablet may be restricted to move freely.

A fitting seat has been designed to free hands. Two connecting rods of a backrest in a vehicle may be clamped with the fitting seat connecting with a mounting base used for fixing a mobile phone or tablet. However, the existing fitting seat is complicated in structure and poor in stability, leading to unstable clamping for the phone or tablet.

### SUMMARY OF THE INVENTION

In view of this, a clamp-type fitting seat and a holder which are of simple structure and stable may be provided in the present disclosure.

According to one aspect of the present disclosure, there is provided a fitting seat, which may include an interconnecting piece and a coupling head arranged on the interconnecting piece. Two ends of the interconnecting piece may be bent toward each other to form first clamping parts. Each of the first clamping parts may have a first bending portion and a second bending portion which are bent in opposite direction. One end of the first bending portion may be connected to the interconnecting piece and the other end may be connected to the second bending portion.

According to another aspect of the present disclosure, a holder is provided, which includes the above-mentioned fitting seat and a mounting base, and the coupling head is connected to the mounting base.

A beneficial effect of the present disclosure is that, by means of bending two ends of the interconnecting piece toward each other to form first clamping parts each having two bending portions (i.e. first bending portions and second bending portions) with opposite bending directions, when the fitting seat is clamped to two connecting rods, the two second bending portions are abutted and pressed against the two connecting rods so that the fitting seat is able to clamp the connecting rods; meanwhile, the first bending portions may increase the deformability of the fitting seat, making the first clamping parts difficult to break and resulting in good stability; in this way, the two ends of the fitting seat are bent to form two bending parts to clamp the two connecting rods, resulting in a simple structure of the fitting seat.

### BRIEF DESCRIPTION OF THE DRAWINGS

The embodiments of the present disclosure may be further understood in conjunction with accompanying drawings. The accompanying drawings constituting a part of the specification are used to illustrate the embodiments of the present disclosure, and explain the principle of the present disclosure together with text description. Obviously, the drawings referred in the following description are only some embodiments of the present disclosure; and based on these drawings, other drawings may be acquired by those skilled in the art without creative labor.

FIG. 1 is a schematically structural diagram of a fitting seat;

FIG. 2 is a schematically structural diagram of the fitting seat from another vision; and

FIG. 3 is a schematically structural diagram of a holder in which the fitting seat is connected to the mounting base and clamped on connecting rods.

Reference signs in these drawings are as follows: fitting seat 1, interconnecting piece 10, clamping part 101, first bending portion 101a, second bending portion 101b, third bending portion 102, second clamping part 103, fourth bending portion 103a, fifth bending portion 103b, clamping space 104, opening 105, skidproof stripe 106, recess 107, coupling head 11, connecting arm 111, universal ball 112, mounting base 2, and connecting rod 3.

### DETAILED DESCRIPTION

It shall be appreciated that the terms used herein and the specific structure and features disclosed are only for describing specific embodiments and are representative. However, the present disclosure can be implemented in many alternative forms and shall not be construed as being limited only to the embodiments set forth here.

In addition, unless otherwise clearly specified and limited, the terms “fitting”, “connecting” and “coupling” shall be understood in a broad sense, for example, connecting fixedly, detachably or integrally; or connecting in a mechanical or electrical manner; or connecting directly or indirectly via an intermediary; or internally connecting between two components. For those skilled in the art, the specific meaning of the above-mentioned terms in the present disclosure may be understood according to specific circumstances.

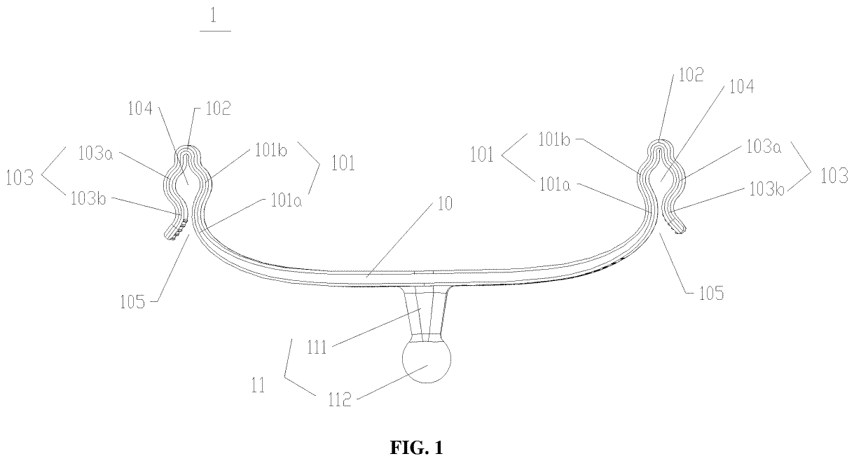

The present disclosure will be further described below with reference to FIGS. 1 to 3 and optional embodiments.

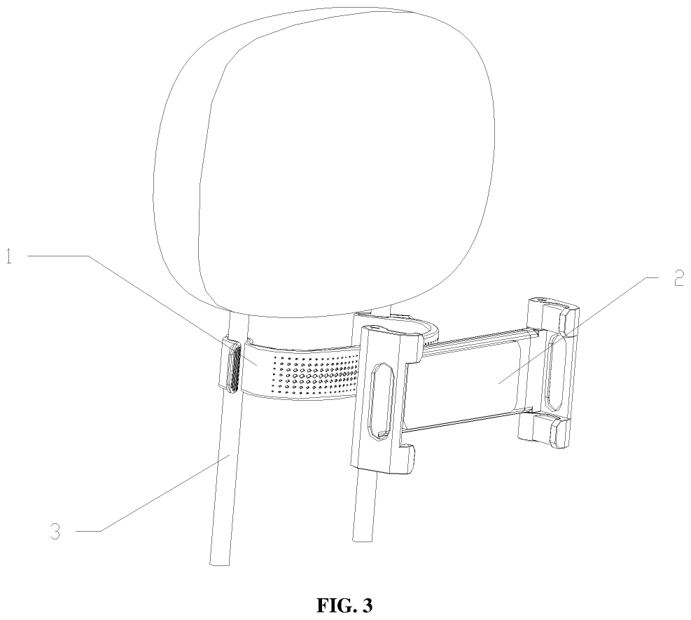

As shown in FIG. 1 and FIG. 3, a clamp-type fitting seat provided in an embodiment of the present disclosure may include an interconnecting piece 10 and a coupling head 11 arranged on the interconnecting piece 10. Two ends of the interconnecting piece 10 are bent toward each other to form first clamping parts 101. The first clamping parts 101 each have two bending portions, first bending portions 101a and second bending portions 101b, with opposite bending directions. One end of each first bending portion 101a is connected to the interconnecting piece 10, and the other end is connected to the second bending portion 101b.

When the fitting seat 1 is clamped to two connecting rods 3 of a backrest, the two second bending portions 101b are abutted and pressed against the two connecting rods 3 so that the fitting seat 1 is able to clamp the connecting rods 3; meanwhile, the first bending portions 101a may increase the deformability of the fitting seat 1, making the first clamping parts 101 difficult to break and resulting in good stability. The two ends of the fitting seat 1 are bent to form two bending parts to clamp the two connecting rods 3; in this respect, the fitting seat 1 is simple in structure.

Furthermore, the interconnecting piece 10 and the coupling head 11 are integrally arranged without loose fixation; in this respect, no displacement between the interconnecting piece 10 and the coupling head 11 occurs and no wobble happen in a mounting base 2, thereby improving the stability of the fitting seat 1.

Specifically, the first clamping part 101 and the second clamping part 103 each are in an “S” shape, but the bending directions of the first clamping part 101 and the second clamping part 103 are different. In this embodiment, a third bending portion 102 is in a “∩” shape so as to widen the opening angle between the first clamping part 101 and the second clamping part 103, enhancing the deformability of the clamping part when it is opened; in this respect, it is not easy to break the fitting seat 1, increasing the stability of the fitting seat 1. Of course, it can be understood that the third bending portion 102 may also be in other shapes, which are not limited herein.

It shall be noted that the fitting seat 1 in this embodiment can be applied not only to a vehicle seat, but also to other products, as long as the fitting seat 1 can be fixed in a certain position.

Furthermore, the fitting 1 may further include third bending portions 102 and second clamping parts 103. The first clamping parts 101 are connected to the second clamping parts 103 via the third bending portions 102; and the second clamping parts 103 and the first clamping parts 101 are symmetrically arranged to form a clamping space 104. With the formed clamping space 104, when the fitting seat 1 is clamped the connecting rods 3, the connecting rods are located within the clamping space 104 to be clamped by the first clamping parts 101 and the second clamping parts 103, making the fitting seat 1 better clamp the connecting rods 3 and not be easy to fall off from the connecting rods 3, thereby increasing the stability of the fitting seat 1. In this way, the two ends of the fitting seat 1 are bent to form the clamping space 104 to clamp the connecting rod 3 more tightly, hence the fitting seat 1 is simple in structure.

Furthermore, each of the second clamping part 103 has a fourth bending portion 103a and a fifth bending portion 103b. One end of the fourth bending portion 103a is connected to the third bending portion 102, and the other end is connected to the fifth bending portion 103b. One end of the fifth bending portion 103b away from the fourth bending portion 103a is inclined in a direction opposite to the bending direction in which the fifth bending portion bends. In this way, each connecting rod 3 can be easily put into the clamping space 104, facilitating the fitting seat 1 to clamp the connecting rod 3.

The interconnecting piece 10, the first clamping parts 101, the third bending portions 102, and the second clamping parts 103 are made of elastic materials; in this way, the deformability of the fitting seat 1 can be increased. Such elastic force of the deformation makes each first clamping part 101 and each second clamping part better clamp each connecting rod 3. Moreover, due to the strong deformability, when the distance between the connecting rods 3 changes, the fitting seat 1 may be adapted to the change of the distance between the connecting rods 3 due to the deformation; thus matching more car seats of different sizes.

Furthermore, the clamping space 104 at each side has an opening 105 facing toward the interconnecting piece 10. The opening is wide close to the clamping space and is narrow away from the clamping space, so that it is not easy for the fitting seat 1 to slip off from the connecting rods 3.

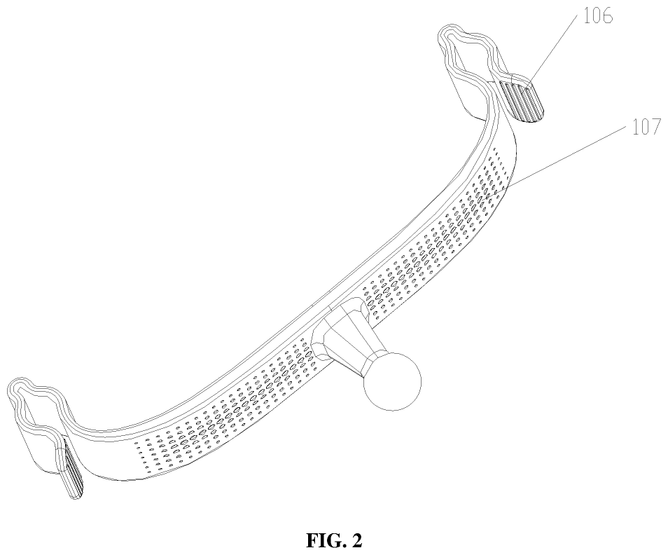

Furthermore, as shown in FIG. 2, skidproof stripes 106 are provided on the inner side of each second clamping part 103; in this respect, the sliding friction of the fitting seat 1 may be increased, making the fitting seat 1 not easily to be slipped off the connecting rod 3. In this embodiment, the skidproof stripes 106 are arranged at the rear of each second clamping part 103 away from the third bending portion.

Furthermore, the second clamping parts 103 each are arranged on one side in a direction in which the two first clamping parts 101 are away from each other. In this way, when a user sits behind a seat of the vehicle, it is convenient for the user to clamp the fitting seat 1 on the connecting rods 3 of the backrest of the seat.

Furthermore, as shown in FIG. 2, a plurality of recesses 107 are provided on the interconnecting piece 10 to make the fitting seat 1 beautiful and reduce the weight thereof.

Furthermore, the coupling head 11 may include a connecting arm 111 coupled to the interconnecting piece 10 and a universal ball 112 coupled to the connecting arm 111. The mounting base 2 is connected with the universal ball 112. By setting the universal ball 112, the mounting base 2 can be rotated 360 degrees. It shall be noted that the coupling head 11 can be used to hang objects, not necessarily connected to the mounting base 2.

A holder provided according to a second aspect of the embodiment may include the fitting seat 1 and the mounting base 2 mentioned above, as shown in FIG. 3; in this respect the coupling head 11 is connected to the mounting base 2.

In this embodiment, the interconnecting piece 10 and the coupling head 11 are integrally arranged. For details, please refer to the description mentioned above, which will not be repeated here.

The present disclosure may be described in detail with reference to the above specific optional embodiments, but the specific implementation of the present disclosure is not limited to such descriptions. A plurality of deductions or substitutions made to the present disclosure by those skilled in the art without departing from the concept of the present disclosure should be regarded as belonging to the protection scope of the present disclosure.

1. A clamp-type fitting seat, comprising an interconnecting piece and a coupling head arranged on the interconnecting piece, wherein two ends of the interconnecting piece are bent toward each other to form first clamping parts, each of the first clamping parts has a first bending portion and a second bending portion which are bent in opposite direction, and one end of the first bending portion is connected to the interconnecting piece and another end is connected to the second bending portion.

2. The fitting seat according to claim 1, wherein the fitting seat further comprises a third bending portion and a second clamping part, each of the first clamping part is connected to the third bending portion via the second clamping part, and the second clamping part and the first clamping part are symmetrically arranged to form a clamping space.

3. The fitting seat according to claim 2, wherein the clamping space has an opening facing the interconnecting piece, and the opening is wide close to the clamping space and narrow away from the clamping space.

4. The fitting seat according to claim 2, wherein the second clamping part has a fourth bending portion and a fifth bending portion; one end of the fourth bending portion is connected to the third bending portion, and the other end is connected to the fifth bending portion; and one end of the fifth bending portion away from the fourth bending portion is inclined toward a direction opposite to the bending direction of the fifth bending portion.

5. The fitting seat according to claim 4, wherein the third bending portion is in an “n” shape.

6. The fitting seat according to claim 4, wherein the interconnecting piece, the first clamping part, the third bending portion and the second clamping part are made of elastic materials.

7. The fitting seat according to claim 2, wherein skidproof stripes are provided on the inner side of the second clamping part.

8. The fitting seat according to claim 2, wherein the second clamping part is arranged on one side in a direction in which the two first clamping parts are away from each other.

9. The fitting seat according to claim 1, wherein a plurality of recesses are provided on the interconnecting piece.

10. A holder, comprising a clamp-type fitting seat according to claim 1 and a mounting base, wherein the coupling head is connected to the mounting base.
